(19) United States
(12) Patent Application Publication
(10) Pub. No.: US 2025/0306202 A1
(43) Pub. Date: Oct. 2, 2025

(54) PROCESSING APPARATUS, PROCESSING METHOD, AND VEHICLE

(71) Applicant: Panasonic Automotive Systems Co., Ltd., Kanagawa (JP)

(72) Inventors: Takeo TOMIDA, Kanagawa (JP); Yoshito HIRAI, Aichi (JP)

(21) Appl. No.: 19/086,667

(22) Filed: Mar. 21, 2025

(30) Foreign Application Priority Data
Mar. 28, 2024 (JP) 2024-053662

(51) Int. Cl. G01S 15/931; B60W 30/09; B60W 30/095

(52) U.S. Cl. CPC G01S 15/931; B60W 30/09; B60W 30/0956; B60W 2420/54; B60W 2422/95; B60W 2554/801; B60W 2556/10; B60W 2710/18; B60W 2710/20

(57) ABSTRACT

A processing apparatus according to an embodiment of the present disclosure includes: a processor; and a memory having instructions that, when executed by the processor, cause the processor to perform operations comprising: inputting a distance measurement value and a past distance measurement value, the distance measurement value indicating a distance to a target object measured by a sensor at a first time point, the past distance measurement value indicating a distance to the target object measured by the sensor at one or more time points earlier than the first time point; determining whether the distance measurement value is valid or invalid based on the distance measurement value, the past distance measurement value, and movement information of the sensor; and outputting a control signal input to a control circuitry of a vehicle on which the sensor is mounted based on a result of the determination.

### TECHNICAL FIELD

The present disclosure relates to a processing apparatus, a processing method, and a vehicle.

### BACKGROUND ART

In the related art, sonars are configured to be mounted on vehicles and the like to detect target objects.

For example, PTL 1 proposes a sonar that improves detection accuracy by using reflection intensity, point cloud specification, endpoint updating, and shape specification.

### CITATION LIST

### Patent Literature

PTL 1
Japanese Patent Application Laid-Open No. 2021-043164

### SUMMARY OF INVENTION

The present disclosure provides a processing apparatus, a processing method, and a vehicle that can improve the calculation accuracy of the position of a target object.

A processing apparatus according to an embodiment of the present disclosure includes: a processor; and a memory having instructions that, when executed by the processor, cause the processor to perform operations comprising: inputting a distance measurement value and a past distance measurement value are input, the distance measurement value indicating a distance to a target object measured by a sensor at a first time point, the past distance measurement value indicating a distance to the target object measured by the sensor at one or more time points earlier than the first time point; determining whether the distance measurement value is valid or invalid based on the distance measurement value, the past distance measurement value, and movement information of the sensor; and outputting a control signal for controlling a controller of a vehicle on which the sensor is mounted based on a result of the determination.

A vehicle according to an embodiment of the present disclosure includes a processing apparatus according to an embodiment of the present disclosure includes: a processor; and a memory having instructions that, when executed by the processor, cause the processor to perform operations comprising:inputting a distance measurement value and a past distance measurement value are input, the distance measurement value indicating a distance to a target object measured by a sensor at a first time point, the past distance measurement value indicating a distance to the target object measured by the sensor at one or more time points earlier than the first time point; determining whether the distance measurement value is valid or invalid based on the distance measurement value, the past distance measurement value, and movement information of the sensor; and outputting a control signal for controlling a controller of a vehicle on which the sensor is mounted based on a result of the determination, the processing apparatus being configured to be mounted on the vehicle.

A processing method according to an embodiment of the present disclosure includes: inputting a distance measurement value and a past distance measurement value, the distance measurement value indicating a distance to a target object measured by a sensor at a first time point, the past distance measurement value indicating a distance to the target object measured by the sensor at one or more time points earlier than the first time point; determining whether the distance measurement value is valid or invalid based on the distance measurement value, the past distance measurement value, and movement information of the sensor; and outputting a signal for controlling a controller of a vehicle on which the sensor is mounted based on a result of the determining.

According to an embodiment of the present disclosure, it is possible to prevent a decrease in the detection accuracy of a target object.

### BRIEF DESCRIPTION OF DRAWINGS

FIG. 1 is a block diagram illustrating an example of a sonar apparatus;

FIG. 2 is a top view illustrating an example of a vehicle;

FIG. 3 is a block diagram illustrating an example of a processing apparatus;

FIG. 4 is a diagram illustrating an example of information stored in a first memory;

FIG. 5 is a diagram illustrating an example of a target;

FIG. 6 is a diagram illustrating an example of a change in a distance measurement value;

FIG. 7 is a diagram illustrating a change in the distance measurement value of a sensor in a case where the target is a wall and a host vehicle moves;

FIG. 8 is a diagram illustrating a method of calculating the coordinates (azimuth) of a target in a case where the target is a pillar, and the relationship between sensor movement distance d_{w} and distance measurement values dₜ and dₜ₋₁;

FIG. 9 is a diagram illustrating an example in which an erroneous coordinate is generated as a coordinate of a target in a case where there is a plurality of reflection points;

FIG. 10 is a diagram illustrating another example in which an erroneous coordinate is generated as a coordinate of a target in a case where a distance measurement value is missing;

FIG. 11 is a diagram illustrating a difference between an erroneous coordinate obtained from two distance measurement values and an actual coordinate;

FIG. 12 is a diagram illustrating an error in a case where sensor movement distance d_{w} is 300 mm and an error up to 25 cm is allowed as a distance measurement value;

FIG. 13 is a diagram illustrating a criterion for determining that distance measurement skipping has occurred;

FIG. 14 is a diagram illustrating an example of a distance measurement value;

FIG. 15 is a diagram illustrating a criterion for determining that a target switching has occurred;

FIG. 16 is a diagram illustrating an example of a distance measurement value;

FIG. 17 is a diagram illustrating an example of a second filter processing;

FIG. 18 is a diagram illustrating another example of the second filter processing; and

FIG. 19 is a flowchart illustrating an example of the determination processing of the target switching performed by the processing apparatus.

### DESCRIPTION OF EMBODIMENTS

Hereinafter, embodiments of the present disclosure will be described in detail with appropriate reference to the drawings.

First, a circuit configuration of sonar apparatus 100 in an embodiment of the present disclosure will be described.

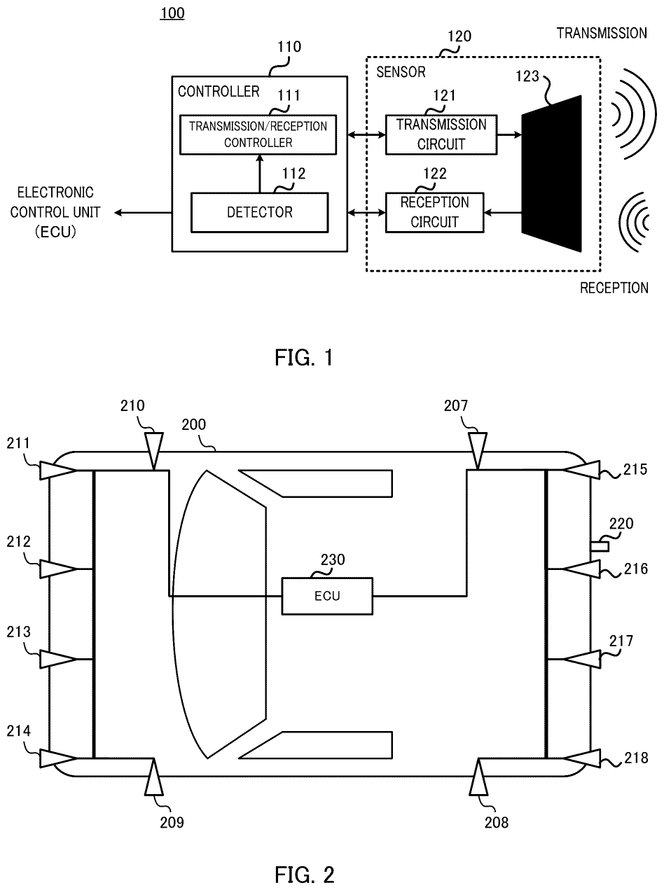

In FIG. 1, sonar apparatus 100 is an apparatus that transmits an ultrasonic signal, receives an ultrasonic signal reflected by a target object (object), and performs detection of the target or the like. For example, sonar apparatus 100 is configured to be mounted on a plurality of vehicles.

Sonar apparatus 100 includes controller 110 and sensor 120. Each sonar apparatus 100 includes one sensor 120, but may include a plurality of sensors 120.

Controller 110 includes transmission/reception controller 111 and detector 112. Controller 110 outputs the detection result of the target object to a vehicle control apparatus (Electronic Control Unit: ECU). The ECU can perform vehicle control, such as activating the emergency brake or controlling the vehicle's traveling direction, based on the detection results from sonar apparatus 100.

Transmission/reception controller 111 controls transmission circuit 121 and reception circuit 122. Transmission/reception controller 111 controls the transmission timing of the ultrasonic signal from circuit 121, the frequency of the ultrasonic signal, and the transmission time for transmitting the ultrasonic signal.

Sensor 120 includes transmission circuit 121, reception circuit 122, and microphone 123.

Transmission circuit 121 generates a transmission signal based on the control of transmission/reception controller 111 and outputs the generated transmission signal to microphone 123.

Reception circuit 122 outputs the reception signal to detector 112 based on the reception signal received from microphone 123. Reception circuit 122 may include a frequency filter, a Fourier transformer, and the like.

Microphone 123 is an electroacoustic transducer that transmits an ultrasonic signal based on the transmission signal received from transmission circuit 121 and transmits a reception signal to reception circuit 122 based on the received ultrasonic signal.

In FIG. 2, vehicle 200 includes sonar apparatuses 207 to 218, muffler 220, and ECU 230. In the example of FIG. 2, six sonar apparatuses 209 to 214 are configured to be mounted on the front portion of vehicle 200, and six sonar apparatuses 207 to 208 and 215 to 218 are configured to be mounted on the rear portion of vehicle 200. Sonars 207 to 210 are configured to be mounted on the side surface of vehicle 200 to detect a target object in the lateral direction of the vehicle, and are referred to also as side sonars. Sonars 211, 214, 215, and 218, also referred to as corner sonars, are disposed near the four corners of the vehicle, and may be used in combination with front sonars 212 and 213 and rear sonars 216 and 217 as an Autonomous Emergency Braking (AEB) system for objects in the front or rear. Note that, in FIG. 2, sonars 211, 214, 215, and 218 are disposed in the front-rear direction, but each may be disposed obliquely outward.

As sonar apparatuses 207 to 218, sonar apparatus 100 in FIG. 1 is used, for example. Further, the number and arrangement of the sonar apparatuses are not limited to those illustrated in FIG. 2. The number of sonar apparatuses configured to be mounted on vehicle 200 may not be eight, and the number of sonar apparatuses configured to be mounted on the front and rear may be different.

ECU 230 is connected to sonar apparatuses 207 to 218 and controls controller 110 of sonar apparatuses 207 to 218.

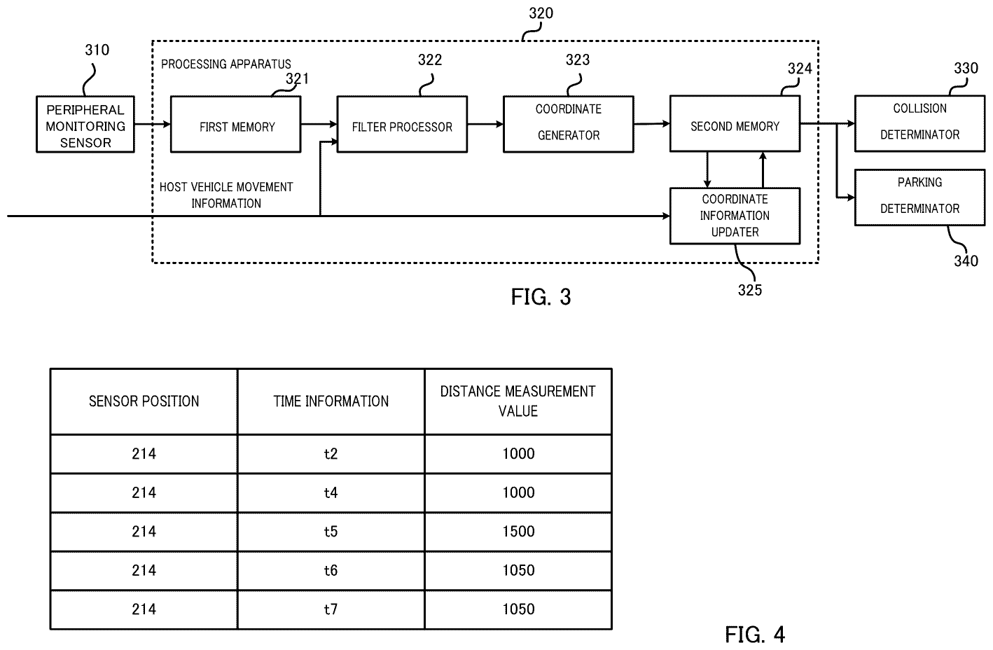

In FIG. 3, processing apparatus 320 includes first memory 321, filter processor 322, coordinate generator 323, second memory 324, and coordinate information updater 325.

Here, processing apparatus 320 may be controller 110 illustrated in FIG. 1 or may be ECU 230 illustrated in FIG. 2. In a case where processing apparatus 320 is controller 110, peripheral monitoring sensor 310 is sensor 120. In a case where processing apparatus 320 is ECU 230, peripheral monitoring sensor 310 is sonar apparatus 100.

Peripheral monitoring sensor 310 transmits an ultrasonic signal at a predetermined cycle and receives a reflected wave from a target object (hereinafter, referred to as “target”) in order to detect the target.

First memory 321 is a storage that stores the distance measurement value received from peripheral monitoring sensor 310. First memory 321 stores at least two previously received distance measurement values. Note that first memory 321 may be referred to as an inputter.

Filter processor 322 performs filter processing on the distance measurement value based on the distance measurement value received from the peripheral monitoring sensor and the past distance measurement value stored in first memory 321. Since peripheral monitoring sensor 310 is configured to be mounted on vehicle 200, the movement amount of peripheral monitoring sensor 310 is given as the movement amount of the host vehicle. Details of the filter processing will be described later.

Coordinate generator 323 generates the coordinate information of peripheral monitoring sensor 310. The coordinate information is represented by coordinates (for example, 150 cm to the left of the host vehicle) with the host vehicle position as a reference. The coordinate information may be represented by coordinates that are not based on the position of the host vehicle. Coordinate generator 323 transmits the generated coordinate information of the sensor to second memory 324. In a case where the coordinate generator 323 has not received the distance measurement value, the coordinate generator 323 does not generate the coordinate information.

Second memory 324 stores the coordinate information in a time series and outputs the coordinate information to a controller configured to be mounted on a vehicle in a subsequent stage. Note that, second memory 324 may be referred to as an outputter.

Coordinate information updater 325 updates the coordinate information stored in second memory 324 based on the movement of the host vehicle. In a case where the coordinate information is information that is not based on the host vehicle, such as position information of a parking lot, the update of the coordinate information may be omitted.

Collision determinator 330 determines whether the host vehicle will collide with the target based on the generated coordinates. In a case where collision determinator 330 determines that there is a possibility of the vehicle colliding with the target, collision determinator 330 performs control to avoid the collision by outputting it to a brake or a vehicle steering section (not illustrated) to operating an emergency brake or operate a steering wheel. Note that collision determinator 330 is a part of a controller of a vehicle on which peripheral monitoring sensor 310 is mounted.

Parking determinator 340 determines the region to which the host vehicle is to be parked based on the generated coordinates. When the parking determinator 340 determines that an empty region larger than the host vehicle is present based on the coordinates of the target object, the parking determinator 340 determines that the empty region is the region to which the host vehicle is to be parked. Note that, parking determinator 340 is a part of a controller of a vehicle on which peripheral monitoring sensor 310 is mounted.

In FIG. 4, filter processor 322 performs filter processing based on the time information and the distance measurement value for each sensor position.

The sensor position is information indicating the position of peripheral monitoring sensor 310. The information 214 registered in the sensor position in FIG. 4 indicates that the registered distance measurement value is a distance measurement value by sonar apparatus 214 in FIG. 2. The distance measurement value of another sonar apparatus is used in the filter processing for each sonar apparatus. In FIG. 4, the distance measurement value at time t3 is not registered, but since the distance measurement value was not received at time t3, there is no data.

The time information is the time at which peripheral monitoring sensor 310 determines the distance measurement value. The time information may be the time at which processing apparatus 320 receives the distance measurement value from peripheral monitoring sensor 310. Peripheral monitoring sensor 310 detects a target at a predetermined cycle, and processing apparatus 320 receives the distance measurement value for each predetermined cycle.

The distance measurement value is calculated based on the Time of Flight (TOF) of peripheral monitoring sensor 310. Peripheral monitoring sensor 310 may calculate the distance measurement value from the TOF such that processing apparatus 320 receives the distance measurement value, or processing apparatus 320 may receive the TOF from peripheral monitoring sensor 310 and calculate the distance measurement value.

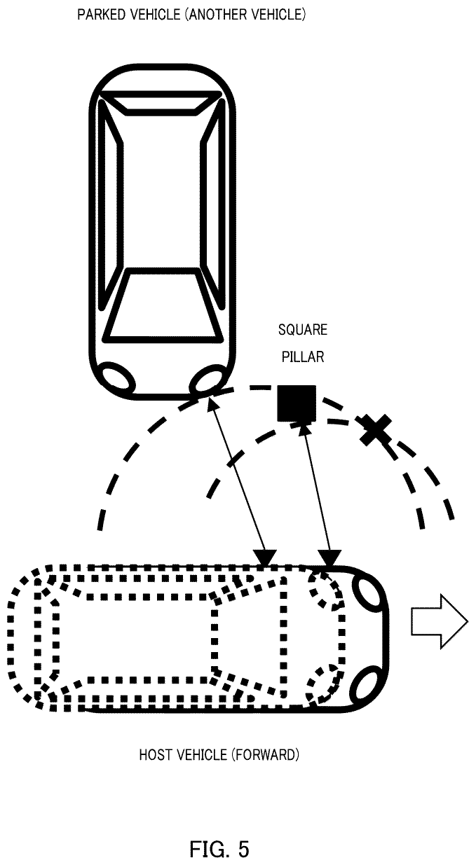

FIG. 5 illustrates an example in which another vehicle is parked near a square pillar in a three-dimensional parking lot or the like, and the vehicle and pillar are located on the left side in the traveling direction of a host vehicle, for example.

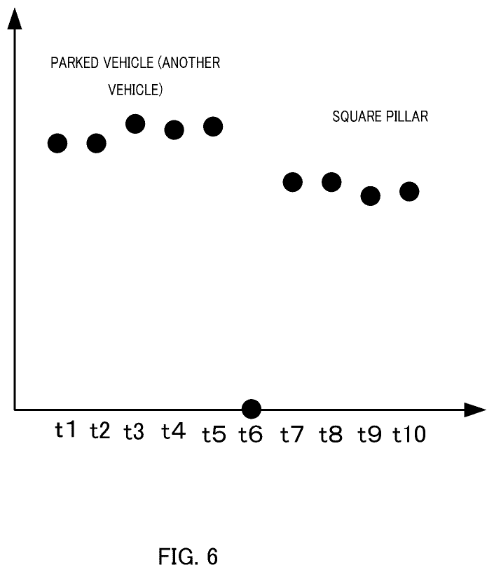

FIG. 6 illustrates an example of the distance measurement value calculated by peripheral monitoring sensor 310 on the left side of the host vehicle in a case where the target illustrated in FIG. 5 is present. From time t1 to time t5, the distance measurement value for another vehicle (parked vehicle) is calculated. At time t6, it is difficult to calculate the distance measurement value or a considerably large distance measurement value is calculated because no reflected wave is received from either another vehicle or the square pillar. From time t7 to time t10, the distance measurement value for the square pillar is calculated.

Next, the filter processing in filter processor 322 will be described. The filter processing is processing that prevents the coordinates of the target from being calculated based on an error in the distance measurement value. Further, the filter processing reduces the erroneous calculation of the detection point by not calculating the coordinates of the target based on the distance measurement value obtained from a combination of different reflection waves in a case where there is a plurality of reflection points, such as H-steel or a plurality of targets.

The filter processing includes first filter processing and second filter processing. The first filter processing is filter processing for determining the distance measurement skipping and the switching of the target based on the azimuth. The first filter is a filter for performing filter processing on the information stored in first memory 321 based on a value (distance measurement value difference/sensor movement distance) obtained by dividing a distance measurement value difference by a sensor movement distance. The distance measurement value difference is a difference in the distance measurement value before and after the movement of the sensor, and the sensor movement distance is a distance that the sensor has moved.

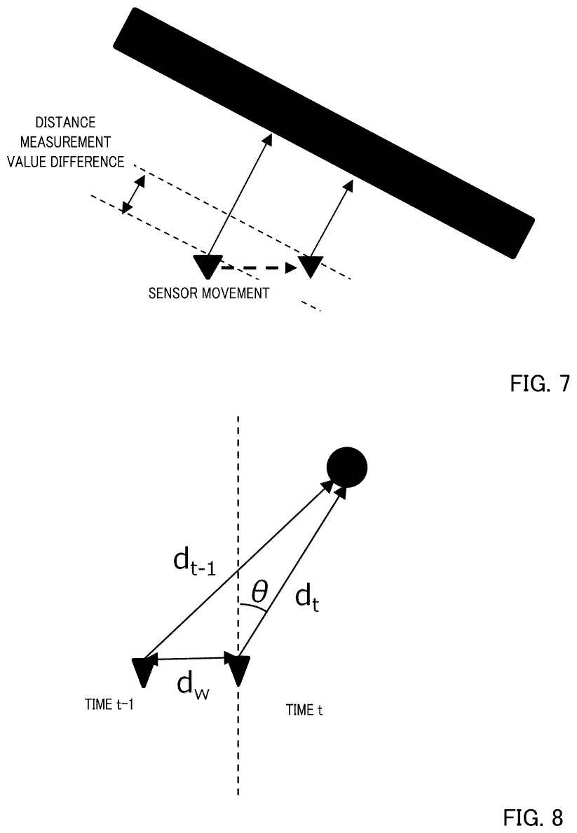

In FIG. 7, the distance measurement value d at time t is denoted as dₜ. Further, sensor movement distance d_{w}, which is the distance between the sensor position (Xt, Yt) at time t and the sensor position (Xₜ₋₁, Yₜ₋₁) at time t−1, can be determined by the following equation.

$${d}_{w} = \sqrt{{( {X}_{t} - {X}_{t - 1} )}^{2} + {( {Y}_{t} - {Y}_{t - 1} )}^{2}} \qquad [ 1 ]$$

Referring to FIG. 8, the above relationship can be approximated by the following equation.

$$\vert {d}_{t} - {d}_{t - 1} \vert / {d}_{w} sin θ \qquad [ 2 ]$$

By this equation, it is possible to calculate the azimuth θ of the target object from sensor movement distance d_{w} and distance measurement values dₜ and dₜ₋₁. Further, the coordinates of the target can be calculated from the sensor position (Xₜ, Y₁), sensor position (Xₜ₋₁, Yₜ₋₁), and distance measurement values dₜ and dₜ₋₁. Azimuth θ is an indicator that increases as the difference between the distance measurement value and the past distance measurement value increases, and decreases as the movement amount of the sensor increases.

In a case where the target is a corner of another vehicle or a pillar, it is sufficient to detect the target within a range that satisfies a field of view (FOV) of the same level as that of a sensor of a known technique with respect to the front surface of the sensor. Further, in a case where the target is a wall, it is sufficient to detect a wall having an angle within a range narrower than the above-described FOV with respect to the front surface of the sensor. Note that, even in the case of a wall, a wall in a range that exceeds the field of view of a sensor of a known technique with respect to the front surface of the sensor may be omitted from detection by the sensor.

Since the present disclosure considers a sonar apparatus that detects a target in a direction lateral to the traveling direction of the host vehicle as described in FIG. 5, a target within a field of view of the same level as that of a sensor of a known technique is a target object in the traveling direction or the retreating direction of the host vehicle. A target in the traveling direction or the retreating direction of the host vehicle may be detected by another sonar apparatus provided on the front surface or the rear surface.

Accordingly, the range that can be effectively detected by the sensor apparatus is set to the same field of view angle θ as that of a sensor of a known technique with respect to the front surface of the sensor apparatus. In consideration of the range in which the sensor apparatus can effectively detect the target, the distance measurement value that satisfies the relationship of |dₜ−dₜ₋₁|/d_{w}≥sin(θ) is removed.

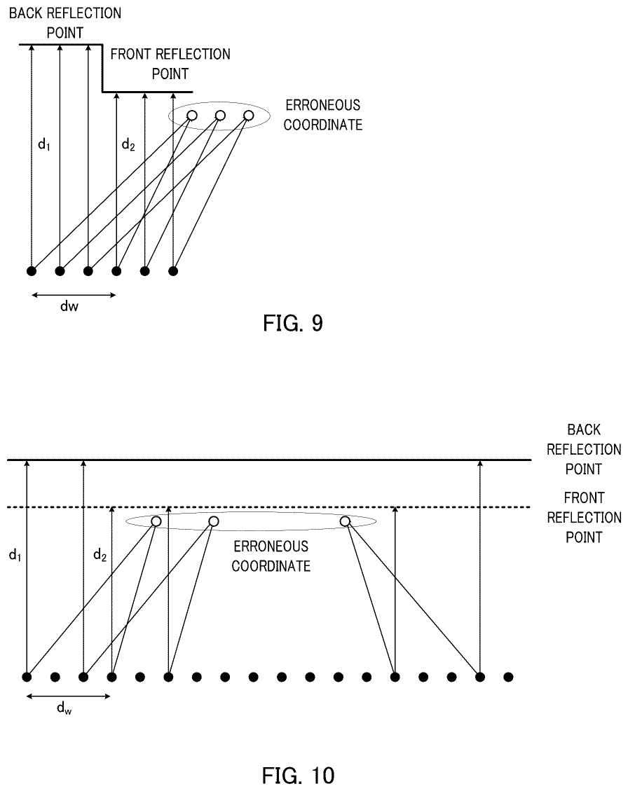

FIG. 9 illustrates an example in which d₁ is obtained as a distance measurement value to a reflection point in the back, and d₂ is obtained as a distance measurement value to a reflection point in the front after the sensor has moved by d_{w}. Since it is difficult for processing apparatus 320 to recognize that the reflection point corresponds to a different distance measurement value, the coordinates of the target are calculated by the method described in FIG. 8 as if the distance measurement value for the same target is obtained. As a result, erroneous coordinates are calculated by processing apparatus 320 as the coordinates of the target as illustrated in FIG. 9.

In FIG. 10, an example is shown in which d₁ is obtained as a distance measurement value to a reflection point in the back, and d₂ is obtained as a distance measurement value to a reflection point in the front after the sensor has moved by d_{w}. Since it is difficult for processing apparatus 320 to recognize that the reflection point corresponds to a different distance measurement value, the coordinates of the target are calculated by the method described in FIG. 8 as if the distance measurement value for the same target is obtained. As a result, erroneous coordinates are calculated by processing apparatus 320 as the coordinates of the target as illustrated in FIG. 10.

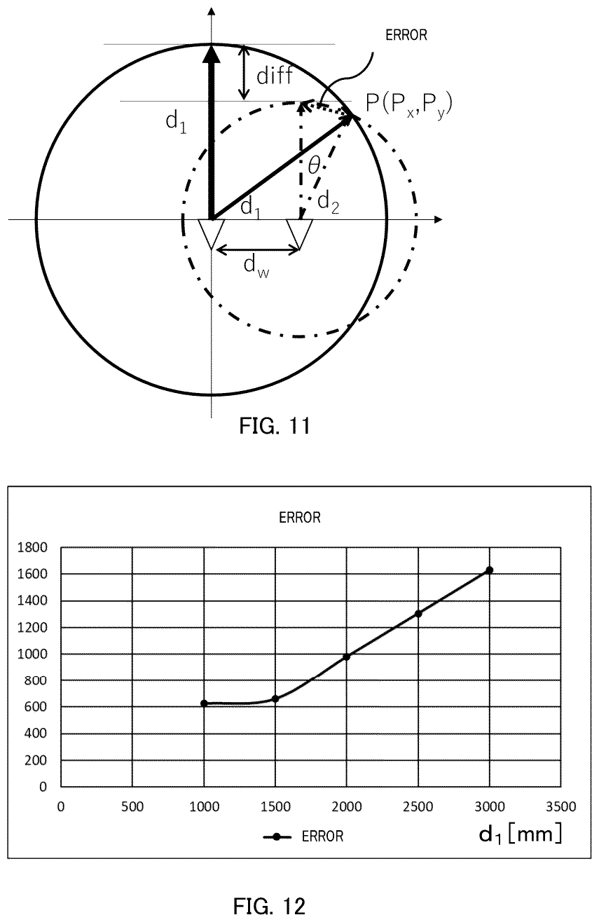

FIG. 11 illustrates a difference between erroneous coordinates obtained from two distance measurement values and actual coordinates. FIG. 12 illustrates coordinates of an actually existing target and an error in coordinates P of a calculated target in a case where the sensor movement distance d_{w} illustrated in FIG. 11 is 300 mm and an error of up to 25 cm is allowed as the distance measurement value (diff≤250 mm). According to FIG. 12, in a case where the two distance measurement values are d₁=2000 mm and d₂=1750 mm, the maximum error in the coordinates calculated based on the distance measurement values may be approximately 1000 mm.

Next, the first filter processing will be described. The first filter processing is filter processing for determining distance measurement skipping and a target switching. The distance measurement skipping indicates a state in which a distance measurement value that is temporarily significantly different is detected, and the target switching indicates that the target has been switched from a reflected wave from target A to a reflected wave from target B, for example.

In the first filter processing, filter processor 322 acquires information on the latest distance measurement value dₜ and sensor position pₜ and the information on the one previous distance measurement value dₜ₋₁ and sensor position pₜ₋₁ from the data stored in first memory 321, and calculates the value of Z01=|dₜ−dₜ₋₁|/∥pₜ−pₜ₋₁∥ from these values. Here, pₜ and pₜ₋₁ are position vectors, and ∥pₜ−pₜ₋₁∥ represents the distance (corresponding to d_{w} described above) between the positions specified by position vectors pₜ and pₜ₋₁. The same applies hereinafter.

Further, filter processor 322 acquires the latest distance measurement value dₜ and sensor position pₜ and the two previous distance measurement value dₜ₋₂ and sensor position pₜ₋₂ from the data stored in first memory 321, and calculates the value of Z02=|dₜ−dₜ₋₂|/∥pₜ-pₜ₋₂∥ from these values.

Further, filter processor 322 acquires one previous distance measurement value dₜ₋₁ and sensor position pₜ₋₁ and two previous distance measurement value dₜ₋₂ and sensor position pₜ₋₂ from the data stored in first memory 321, and calculates the value of Z12=|dₜ₋₁ dₜ₋₂|/∥pₜ₋₁-pₜ₋₂∥ from these values.

Note that, in calculating value Z12, the N-th previous distance measurement value and the M-th previous distance measurement value (N and M are integers satisfying 1<N<M) may be used instead of the one previous distance measurement value and the two previous distance measurement values. Here, it is desirable that the time from the current time to the N-th previous distance measurement time point and the time from the N-th previous distance measurement time point to the M-th previous distance measurement time point are equal to each other, but they may be different from each other. Further, the latest distance measurement value received from peripheral monitoring sensor 310 may be used as it is by filter processor 322 without being stored in first memory 321.

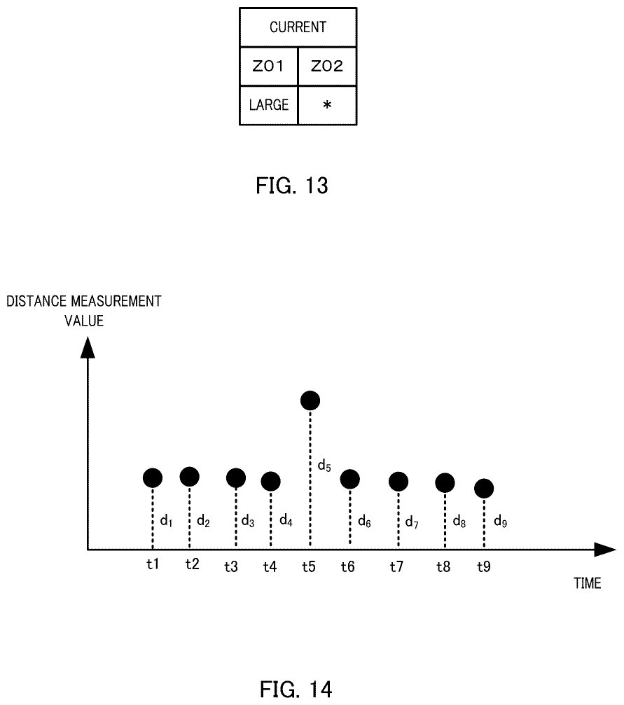

FIG. 13 illustrates a criterion for determining that distance measurement skipping has occurred in the first filter processing. In the figure, “*” indicates a criterion that is not related to the determination (don't care).

In a case where the value |dₜ−dₜ₋₁|/d_{w} calculated based on the difference between distance measurement value dₜ and distance measurement value dₜ₋₁ is larger than the threshold, filter processor 322 determines that the distance measurement skipping has occurred. In FIG. 14, a large difference (value of Z01) between the current distance measurement value (time t5) and the one previous distance measurement value (time t4) indicates that the distance measurement value has largely changed, and therefore, it can be determined from FIG. 13 that distance measurement skipping has occurred.

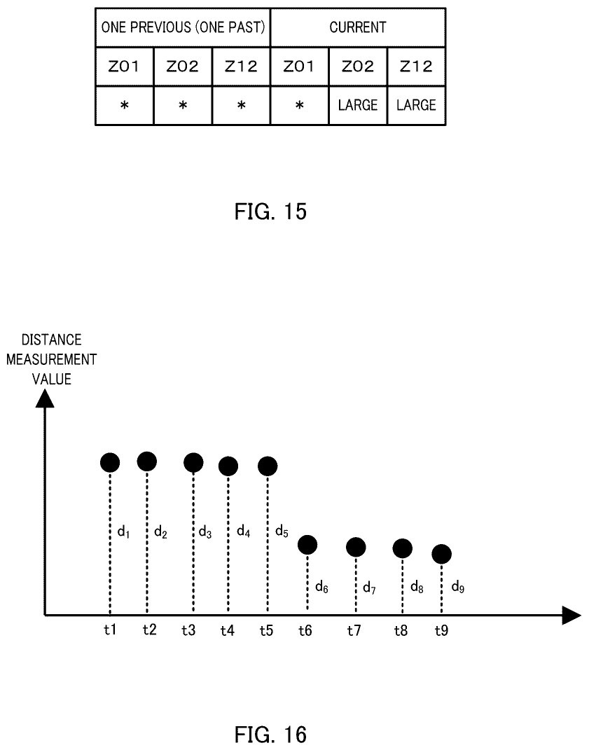

FIG. 15 illustrates a criterion for determining that a target switching has occurred in the first filter processing, where “*” indicates a criterion that is not related to the determination (don't care). Further, FIG. 16 illustrates an example in which substantially equal distance measurement values of the same target are received until time t5, but after time t6, the target is switched and different distance measurement values than before time t5 are received.

In a case where the difference (value of Z02) between the current distance measurement value and the two previous distance measurement value is large, and the difference (value of Z12) between the one previous distance measurement value and the two previous distance measurement value is also large, the distance measurement value has largely changed from the two previous time point (t5 in FIG. 16) at the one previous time point (t6 in FIG. 16), and the distance measurement value has also largely changed from the two previous time point (t5 in FIG. 16) at the current time point (t7 in FIG. 16), and thus, filter processor 322 determines that the target switching has occurred.

Note that, in this case since the target in front of the sensor (vehicle side surface) is the object to be measured and a wall at a steep angle with respect to the front is not a detection target of the sensor, a continuous significant change in the distance measurement value is unlikely to occur, and therefore the target switching can be determined based on the fact that both the value of Z12 and the value of Z02 are large.

As described above, in the first filter processing, the target switching is determined based on whether the change in the distance measurement value corresponding to the sensor movement distance is large or small. In a case where the distance measurement value is difficult to calculate or is not received, the sensor movement distance from the one previous distance measurement value is long, and consequently there is a possibility that the value obtained by dividing the distance measurement value difference by the sensor movement distance may be small, thus making it difficult for the filter processor 322 to determine the target switching.

Note that, the value of Z02 is calculated from the current distance measurement value and the two previous distance measurement value, and therefore the sensor movement distance is large. As a result, the value of |dₜ−dₜ₋₂|/d_{w} is small, and there is a possibility that a situation in which an occurrence of the target switching is not determined may occur. In a case where the distance measurement value is not received, the movement distance from the two previous distance measurement time points is further larger, and thus, the value of |dₜ−dₜ₋₂|/d_{w} may be further smaller.

Further, in FIG. 16, when the host vehicle is moving at a constant velocity, sensor movement distance d_{w} is equal between each distance measurement time point. In such a case, the value of Z02 at time t6 is calculated as |d₆−d₄|/d_{w}.

However, in a case where the distance measurement value d5 at time t5 is not received, the value of Z02 at time t6 is calculated as |d₆−d₃|/2d_{w}. In a case where d₄ and d₃ are substantially equal, the value of Z02 decreases by the increase in d_{w} due to the non-reception of the distance measurement value d5, and consequently it may be determined that the condition for target switching is not satisfied.

For example, there is a possibility that the distance measurement values until time t5 and after time t6 are not determined to be distance measurement values of different targets, thus causing an error in the coordinates of the target generated by the coordinate generator 323.

The same phenomenon may also occur in a case where the speed of the vehicle increases, because sensor movement distance d_{w} becomes large.

This is a reason for the use of a second filter that determines target switching regardless of the sensor movement distance. It is determined that a target switching has occurred in a case where it is determined that the target switching has occurred based on either the determination at the first filter or the determination at the second filter.

Hereinafter, a second filter processing used for such a phenomenon will be described.

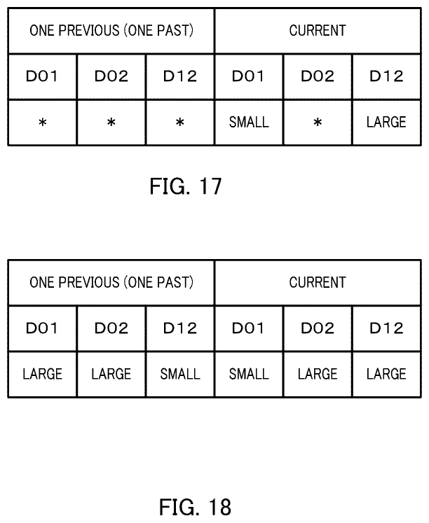

In the second filter processing in FIG. 17, filter processor 322 acquires the latest distance measurement value dₜ and the one previous distance measurement value dₜ₋₁ from the data stored in first memory 321, and calculates the value of D01=|dₜ−dₜ₋₁|.

Further, filter processor 322 acquires the latest distance measurement value dₜ and the two previous distance measurement value dₜ₋₂ from the data stored in first memory 321, and calculates the value of D02=|dₜ−dₜ₋₂|.

Further, filter processor 322 acquires one previous distance measurement value dₜ₋₁ and two previous distance measurement value dₜ₋₂ from the data stored in first memory 321, and calculates the value of D12=|dₜ₋₁−dₜ₋₂|.

The second filter processing is based on the condition that the value of D12 is large and the value of D01 is small. This indicates that the distance measurement value has largely changed from two previous time point to one previous time point, and that the current distance measurement value is substantially the same as the distance measurement value at one previous time point.

For this reason, filter processor 322 determines that a target switching has occurred in a case where the value of D12 is larger than the first threshold and the value of D01 is smaller than the second threshold.

Further, even in a case where the distance measurement value of t5 has not been received in FIG. 16, the value of D12 at the time point of t7 is |d₆−d₄| using the distance measurement value at the time point of t4 as the two previous distance measurement value, and the value of D01 is |d₇−d₆|. Thus, the fact that a switch of the target at t7 can be detected even in a case where the distance measurement value of t5 has not been received.

Note that the second filter processing is not limited to the above processing, and may be as follows.

In the filter processing of FIG. 18, the values of D01, D02, and D12 at the current time point and the values of D01, D02, and D12 at the one previous time point are considered. The values of D01, D02, and D12 at the one previous time point may be stored as the values of D01, D02, and D12 at the current time point, or may be calculated as the values of D12, D13, and D23 at the current time point. Specifically, the condition is that the values of D01 and D02 at the one previous time point are large, that the value of D12 is small, that the value of D01 at the current time point is small, and that the values of D02 and D12 are large.

The distance measurement value has not largely changed in D12 at the one previous time point (one previous and two previous time points, or, from the current time point, two previous and three previous time points), but the distance measurement value has largely changed at the one previous time point (one previous D01, equal to D12 at the current time point), and the distance measurement value has not largely changed even at the current time point from the distance measurement value at the one previous time point. This indicates that, from the current time point, the distance measurement value has not largely changed at the two previous time points and three previous time points (the value of D12 at the one previous time point is small), but the distance measurement value has largely changed at the one previous time point (the values of D01 and D02 at the one previous time point are large, and the values of D02 and D12 at the current time point are large), and the distance measurement value has not largely changed from the distance measurement value at the one previous time point even at the current time point (the value of D01 at the current time point is small).

For this reason, filter processor 322 determines that a target switching has occurred in a case where the values of D01 and D02 at the one previous time point are large, the value of D12 is small, the value of D01 at the current time point is small, and the values of D02 and D12 are large.

Further, even in a case where the distance measurement value of t5 has not been received in FIG. 16, at the time point of t7, the value of D12 at the one previous time point is |d₄−d₃|, the value of D01 at the one previous time point is |d₆−d₄|, the value of D02 at the one previous time point is |d₆−d₃|, the value of D12 at the current time point is |d₆−d₄|, the value of D01 at the current time point is |d₇−d₆|, and the value of D02 at the current time point is |d₇−d₄|.

Thus, even in a case where the distance measurement value has not been received at time point t5, it is possible to detect that the target has been switched at time point t7.

The condition of FIG. 17 can easily determine the switching of the target, whereas the condition of FIG. 18 can determine the switching of the target more reliably.

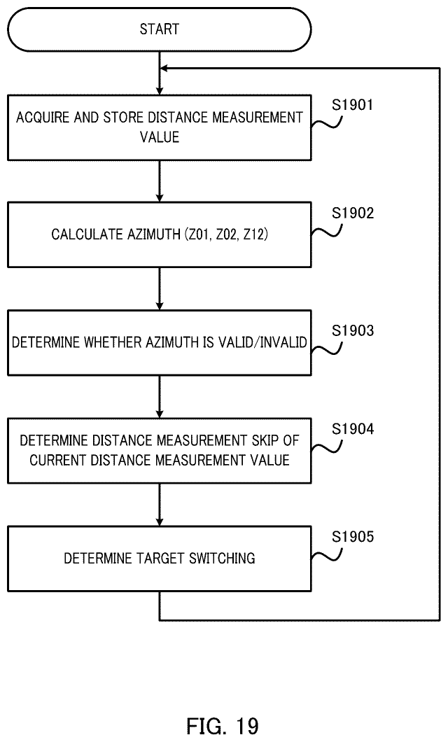

Next, determination processing of the target switching performed by processing apparatus 320 will be described with reference to FIG. 19.

First, first memory 321 of processing apparatus 320 receives and stores a distance measurement value measured by peripheral monitoring sensor 310 (step S1901).

Then, filter processor 322 calculates the azimuth information (Z01, Z02, Z12) using the current distance measurement value dₜ, the one previous distance measurement value dₜ₋₁, and the two previous distance measurement value dₜ₋₂ (step S1902).

Subsequently, filter processor 322 determines whether the calculated azimuth information is valid or invalid. If the azimuth information is less than sin(θ) in FIG. 8, the calculated azimuth information is valid, and if the azimuth information is equal to or greater than sin(θ) in FIG. 8, the calculated azimuth information is invalid. The invalid azimuth information is not used in the subsequent processing (step S1903).

Next, filter processor 322 determines whether distance measurement skipping has occurred. In a case where the value of Z01 described above is larger than the threshold, filter processor 322 determines that distance measurement skipping has occurred at the time point of dₜ(step S1904). Note that, the distance measurement value determined to have distance measurement skipping is not used for calculating the coordinates of the target.

Subsequently, filter processor 322 determines whether the target switching has occurred. For example, as described with reference to FIG. 15, in a case where the values of Z02 and Z12 are larger than the threshold, filter processor 322 determines that the target switching has occurred at the time point of dₜ. Further, as described with reference to FIGS. 17 and 18, it is determined that the target switching has occurred using the values of D01, D02, and D12. In a case where either of the conditions in FIG. 15 or FIG. 18 (or FIG. 17) is satisfied, it is determined that a target switching has occurred (step S1905).

Note that, in a case where it is determined that the target switching has occurred, the processing of generating the coordinates of the target using the distance measurement value before the target switching and the distance measurement value after the target switching is not executed.

When the presence or absence of the target switching is determined in step S1905, the process returns to step S1901, and first memory 321 acquires the next distance measurement value. Subsequent processing is then continued.

In the above-mentioned embodiments, the notation “ . . . apparatus” used for each component may be replaced by other notations such as “ . . . circuitry,” “ . . . assembly,” “. . . device,” “ . . . unit,” or “ . . . module.

The present disclosure can be realized in software, hardware, or software in conjunction with hardware. Each functional block used in the description of the above embodiments may be partially or entirely realized as an LSI, an integrated circuit, and each process described in the above embodiments may be partially or entirely controlled by a single LSI or a combination of LSIs. The LSI may be composed of individual chips or may be composed of a single chip to include some or all of the functional blocks. The LSI may have data inputs and outputs. LSIs may be referred to as ICs, system LSIs, super LSIs, or ultra LSIs, depending on the degree of integration.

The method of integrated circuitry is not limited to LSI, but may be realized by dedicated circuits, general-purpose processors or dedicated processors. Field Programmable Gate Array (FPGA), which can be programmed after LSI manufacturing, and reconfigurable processors, which can reconfigure the connections and settings of circuit cells inside the LSI, may also be used. The disclosure may be realized as digital or analog processing.

Furthermore, if a technology for integrated circuits replacing LSI appears due to advances in semiconductor technology or another derived technology, the integration of functional blocks may naturally be achieved using that technology. The application of biotechnology, etc. may be a possibility.

(1) A processing apparatus according to an embodiment of the present disclosure includes: a processor; and a memory having instructions that, when executed by the processor, cause the processor to perform operations comprising:inputting a distance measurement value and a past distance measurement value, the distance measurement value indicating a distance to a target object measured by a sensor at a first time point, the past distance measurement value indicating a distance to the target object measured by the sensor at one or more time points earlier than the first time point; determining whether the distance measurement value is valid or invalid based on the distance measurement value, the past distance measurement value, and movement information of the sensor; and outputting a control signal input a control circuitry of a vehicle on which the sensor is mounted based on a result of the determination.

(2) In the processing apparatus processing apparatus of an embodiment of the present disclosure according to (1), whether the distance measurement value is valid or invalid by determining a direction in which the target object is present based on the distance measurement value, the past distance measurement value, and the movement information of the sensor.

(3) In the processing apparatus processing apparatus of an embodiment of the present disclosure according to (1), whether the distance measurement value is valid or invalid based on an indicator, the indicator being an indicator that increases as a difference between the distance measurement value and the past distance measurement value increases and decreases as a movement amount of the sensor increases.

(4) In the processing apparatus processing apparatus of an embodiment of the present disclosure according to (3), the past distance measurement value includes a first past distance measurement value and a second past distance measurement value, the first past distance measurement value indicating a distance to the target object measured by the sensor at a second time point earlier than the first time point, the second past distance measurement value indicating a distance to the target object measured by the sensor at a third time point earlier than the second time point, and whether the target object has switched from a first target object to a second target object based on a first indicator and a second indicator, the first indicator being an indicator that increases as a difference between the distance measurement value and the second past distance measurement value increases and decreases as the movement amount of the sensor increases, the second indicator being an indicator that increases as a difference between the first past distance measurement value and the second past distance measurement value increases and decreases as the movement amount of the sensor increases.

(5) In the processing apparatus processing apparatus of an embodiment of the present disclosure according to (3), the past distance measurement value includes a first past distance measurement value and a second past distance measurement value, the first past distance measurement value indicating a distance to the target object measured by the sensor at a second time point earlier than the first time point, the second past distance measurement value indicating a distance to the target object measured by the sensor at a third time point earlier than the second time point, and whether the target object has switched from a first target object to a second target object based on the indicator, a first indicator and a second indicator, the first indicator being an indicator that increases as a difference between the distance measurement value and the first past distance measurement value increases, the second indicator being an indicator that increases as a difference between the first past distance measurement value and the second past distance measurement value increases.

(6) In the processing apparatus processing apparatus of an embodiment of the present disclosure according to (3), the past distance measurement value includes a first past distance measurement value, a second past distance measurement value, and a third past distance measurement value, the first past distance measurement value indicating a distance to the target object measured by the sensor at a second time point earlier than the first time point, the second past distance measurement value indicating a distance to the target object measured by the sensor at a third time point earlier than the second time point, the third past distance measurement value indicating a distance to the target object measured by the sensor at a fourth time point earlier than the third time point, and whether the target object has switched from a first target object to a second target object based on the indicator, a first indicator, a second indicator, a third indicator, a fourth indicator, a fifth indicator, and a sixth indicator, the first indicator being an indicator that increases as a difference between the distance measurement value and the first past distance measurement value increases, the second indicator being an indicator that increases as a difference between the distance measurement value and the second past distance measurement value increases, the third indicator being an indicator that increases as a difference between the first past distance measurement value and the second past distance measurement value increases, the fourth indicator being an indicator that increases as the difference between the first past distance measurement value and the second past distance measurement value increases, the fifth indicator being an indicator that increases as a difference between the first past distance measurement value and the third past distance measurement value increases, the sixth indicator being an indicator that increases as a difference between the second past distance measurement value and the third past distance measurement value increases.

(7) In the processing apparatus processing apparatus of an embodiment of the present disclosure according to any one of (4), in a case where the target object has switched from the first target object to the second target object, the measurement value related to the first target object is not use to generate coordinates of the second target object.

(8) A vehicle according to an embodiment of the present disclosure includes the processing apparatus according to (1), the processing apparatus being configured to be mounted on the vehicle.

(9) A processing method according to an embodiment of the present disclosure includes: inputting a distance measurement value and a past distance measurement value, the distance measurement value indicating a distance to a target object measured by a sensor at a first time point, the past distance measurement value indicating a distance to the target object measured by the sensor at one or more time points earlier than the first time point; determining whether the distance measurement value is valid or invalid based on the distance measurement value, the past distance measurement value, and movement information of the sensor; and outputting a signal for controlling a controller of a vehicle on which the sensor is mounted based on a result of the determining.

(10) In processing method of an embodiment of the present disclosure according to (9), whether the distance measurement value is valid or invalid is determined by determining a direction in which the target object is present based on the distance measurement value, the past distance measurement value, and the movement information of the sensor.

(11) In processing method of an embodiment of the present disclosure according to (9), whether the distance measurement value is valid or invalid is determined based on an indicator, the indicator being an indicator that increases as a difference between the distance measurement value and the past distance measurement value increases and decreases as a movement amount of the sensor increases.

(12) In processing method of an embodiment of the present disclosure according to (11), the past distance measurement value includes a first past distance measurement value and a second past distance measurement value, the first past distance measurement value indicating a distance to the target object measured by the sensor at a second time point earlier than the first time point, the second past distance measurement value indicating a distance to the target object measured by the sensor at a third time point earlier than the second time point, and whether the target object has switched from a first target object to a second target object is determined based on a first indicator and a second indicator, the first indicator being an indicator that increases as a difference between the distance measurement value and the second past distance measurement value increases and decreases as the movement amount of the sensor increases, the second indicator being an indicator that increases as a difference between the first past distance measurement value and the second past distance measurement value increases and decreases as the movement amount of the sensor increases.

(13) In processing method of an embodiment of the present disclosure according to (11), the past distance measurement value includes a first past distance measurement value and a second past distance measurement value, the first past distance measurement value indicating a distance to the target object measured by the sensor at a second time point earlier than the first time point, the second past distance measurement value indicating a distance to the target object measured by the sensor at a third time point earlier than the second time point, whether the target object has switched from a first target object to a second target object is determined based on the indicator, a first indicator and a second indicator, the first indicator being an indicator that increases as a difference between the distance measurement value and the first past distance measurement value increases, the second indicator being an indicator that increases as a difference between the first past distance measurement value and the second past distance measurement value increases.

(14) In processing method of an embodiment of the present disclosure according to (11), the past distance measurement value includes a first past distance measurement value, a second past distance measurement value, and a third past distance measurement value, the first past distance measurement value indicating a distance to the target object measured by the sensor at a second time point earlier than the first time point, the second past distance measurement value indicating a distance to the target object measured by the sensor at a third time point earlier than the second time point, the third past distance measurement value indicating a distance to the target object measured by the sensor at a fourth time point earlier than the third time point, and whether the target object has switched from a first target object to a second target object is determined based on the indicator, a first indicator, a second indicator, a third indicator, a fourth indicator, a fifth indicator, and a sixth indicator, the first indicator being an indicator that increases as a difference between the distance measurement value and the first past distance measurement value increases, the second indicator being an indicator that increases as a difference between the distance measurement value and the second past distance measurement value increases, the third indicator being an indicator that increases as a difference between the first past distance measurement value and the second past distance measurement value increases, the fourth indicator being an indicator that increases as the difference between the first past distance measurement value and the second past distance measurement value increases, the fifth indicator being an indicator that increases as a difference between the first past distance measurement value and the third past distance measurement value increases, the sixth indicator being an indicator that increases as a difference between the second past distance measurement value and the third past distance measurement value increases.

(15) In the processing method of an embodiment of the present disclosure according to any one of (12) to (14), in a case where the target object has switched from the first target object to the second target object, the measurement value related to the first target object is not used to generate coordinates of the second target object.

(16) In the processing apparatus processing apparatus of an embodiment of the present disclosure according to (1), the instructions which, when executed by the hardware processor, further cause the hardware processor to perform operations comprising: calculating coordinates of the target object based on the distance measurement value.

(17) In the processing apparatus processing apparatus of an embodiment of the present disclosure according to (16), in a case where the distance measurement value is determined to be a distance measurement value that is temporarily significantly different, the distance measurement value is not used in calculation of the coordinates of the target object.

(18) In the processing apparatus processing apparatus of an embodiment of the present disclosure according to (3), in a case where the indicator is larger than a threshold, the distance measurement value is determined to be temporarily significantly different.

(19) In the vehicle of an embodiment of the present disclosure according to (8), the instructions which, when executed by the hardware processor, further cause the hardware processor to perform operations comprising: determining a possibility of collision of the vehicle with the target object based on coordinates of the target object, and outputting the control signal for causing the vehicle to avoid collision to the vehicle when there is the possibility of collision.

(20) In the vehicle of an embodiment of the present disclosure according to (8), the sensor is configured to be a sensor which, in operation, detects a target in a direction lateral to a traveling direction of the vehicle.

While various embodiments have been described herein above, it is to be appreciated that various changes in form and detail may be made without departing from the spirit and scope of the invention(s) presently or hereafter claimed.

The disclosure of Japanese Patent Application No. 2024-053662, filed on Mar. 28, 2024, including the specification, drawings and abstract, is incorporated herein by reference in its entirety.

### INDUSTRIAL APPLICABILITY

The present disclosure is useful for a processing apparatus and a vehicle.

### REFERENCE SIGNS LIST

100, 207 to 218 Sonar apparatus
110 Controller
111 Transmission/reception controller
112 Detector
120 Sensor
121 Transmission circuit
122 Reception circuit
123 Microphone
200 Vehicle
220 Muffler
230 ECU
310 Peripheral monitoring sensor
320 Processing apparatus
321 First memory
322 Filter processor
323 Coordinate generator
324 Second memory
325 Coordinate information updater
330 Collision determinator
340 Parking determinator

1. A processing apparatus comprising:
a processor; and
a memory having instructions that, when executed by the processor, cause the processor to perform operations comprising:
inputting a distance measurement value and a past distance measurement value, the distance measurement value indicating a distance to a target object measured by a sensor at a first time point, the past distance measurement value indicating a distance to the target object measured by the sensor at one or more time points earlier than the first time point;
determining whether the distance measurement value is valid or invalid based on the distance measurement value, the past distance measurement value, and movement information of the sensor; and
outputting a control signal input to a control circuitry of a vehicle on which the sensor is mounted based on a result of the determination.

2. The processing apparatus according to claim 1,
wherein whether the distance measurement value is valid or invalid by determining a direction in which the target object is present based on the distance measurement value, the past distance measurement value, and the movement information of the sensor.

3. The processing apparatus according to claim 1,
wherein whether the distance measurement value is valid or invalid based on an indicator, the indicator being an indicator that increases as a difference between the distance measurement value and the past distance measurement value increases and decreases as a movement amount of the sensor increases.

4. The processing apparatus according to claim 3,
wherein the past distance measurement value includes a first past distance measurement value and a second past distance measurement value, the first past distance measurement value indicating a distance to the target object measured by the sensor at a second time point earlier than the first time point, the second past distance measurement value indicating a distance to the target object measured by the sensor at a third time point earlier than the second time point, and
wherein whether the target object has switched from a first target object to a second target object based on a first indicator and a second indicator, the first indicator being an indicator that increases as a difference between the distance measurement value and the second past distance measurement value increases and decreases as the movement amount of the sensor increases, the second indicator being an indicator that increases as a difference between the first past distance measurement value and the second past distance measurement value increases and decreases as the movement amount of the sensor increases.

5. The processing apparatus according to claim 3,
wherein the past distance measurement value includes a first past distance measurement value and a second past distance measurement value, the first past distance measurement value indicating a distance to the target object measured by the sensor at a second time point earlier than the first time point, the second past distance measurement value indicating a distance to the target object measured by the sensor at a third time point earlier than the second time point, and
wherein whether the target object has switched from a first target object to a second target object based on the indicator, a first indicator and a second indicator, the first indicator being an indicator that increases as a difference between the distance measurement value and the first past distance measurement value increases, the second indicator being an indicator that increases as a difference between the first past distance measurement value and the second past distance measurement value increases.

6. The processing apparatus according to claim 3,
wherein the past distance measurement value includes a first past distance measurement value, a second past distance measurement value, and a third past distance measurement value, the first past distance measurement value indicating a distance to the target object measured by the sensor at a second time point earlier than the first time point, the second past distance measurement value indicating a distance to the target object measured by the sensor at a third time point earlier than the second time point, the third past distance measurement value indicating a distance to the target object measured by the sensor at a fourth time point earlier than the third time point, and
wherein whether the target object has switched from a first target object to a second target object based on the indicator, a first indicator, a second indicator, a third indicator, a fourth indicator, a fifth indicator, and a sixth indicator, the first indicator being an indicator that increases as a difference between the distance measurement value and the first past distance measurement value increases, the second indicator being an indicator that increases as a difference between the distance measurement value and the second past distance measurement value increases, the third indicator being an indicator that increases as a difference between the first past distance measurement value and the second past distance measurement value increases, the fourth indicator being an indicator that increases as the difference between the first past distance measurement value and the second past distance measurement value increases, the fifth indicator being an indicator that increases as a difference between the first past distance measurement value and the third past distance measurement value increases, the sixth indicator being an indicator that increases as a difference between the second past distance measurement value and the third past distance measurement value increases.

7. The processing apparatus according to any one of claim 4,
wherein in a case where the target object has switched from the first target object to the second target object, the measurement value related to the first target object is not use to generate coordinates of the second target object.

8. A vehicle comprising the processing apparatus according to claim 1, the processing apparatus being configured to be mounted on the vehicle.

9. A processing method comprising:
inputting a distance measurement value and a past distance measurement value, the distance measurement value indicating a distance to a target object measured by a sensor at a first time point, the past distance measurement value indicating a distance to the target object measured by the sensor at one or more time points earlier than the first time point;
determining whether the distance measurement value is valid or invalid based on the distance measurement value, the past distance measurement value, and movement information of the sensor; and
outputting a signal for controlling a controller of a vehicle on which the sensor is mounted based on a result of the determining.

10. The processing method according to claim 9,
wherein whether the distance measurement value is valid or invalid is determined by determining a direction in which the target object is present based on the distance measurement value, the past distance measurement value, and the movement information of the sensor.

11. The processing method according to claim 9,
wherein whether the distance measurement value is valid or invalid is determined based on an indicator, the indicator being an indicator that increases as a difference between the distance measurement value and the past distance measurement value increases and decreases as a movement amount of the sensor increases.

12. The processing method according to claim 11,
wherein the past distance measurement value includes a first past distance measurement value and a second past distance measurement value, the first past distance measurement value indicating a distance to the target object measured by the sensor at a second time point earlier than the first time point, the second past distance measurement value indicating a distance to the target object measured by the sensor at a third time point earlier than the second time point, and
wherein whether the target object has switched from a first target object to a second target object is determined based on a first indicator and a second indicator, the first indicator being an indicator that increases as a difference between the distance measurement value and the second past distance measurement value increases and decreases as the movement amount of the sensor increases, the second indicator being an indicator that increases as a difference between the first past distance measurement value and the second past distance measurement value increases and decreases as the movement amount of the sensor increases.

13. The processing method according to claim 11,
wherein the past distance measurement value includes a first past distance measurement value and a second past distance measurement value, the first past distance measurement value indicating a distance to the target object measured by the sensor at a second time point earlier than the first time point, the second past distance measurement value indicating a distance to the target object measured by the sensor at a third time point earlier than the second time point, and
wherein whether the target object has switched from a first target object to a second target object is determined based on the indicator, a first indicator and a second indicator, the first indicator being an indicator that increases as a difference between the distance measurement value and the first past distance measurement value increases, the second indicator being an indicator that increases as a difference between the first past distance measurement value and the second past distance measurement value increases.

14. The processing method according to claim 11,
wherein the past distance measurement value includes a first past distance measurement value, a second past distance measurement value, and a third past distance measurement value, the first past distance measurement value indicating a distance to the target object measured by the sensor at a second time point earlier than the first time point, the second past distance measurement value indicating a distance to the target object measured by the sensor at a third time point earlier than the second time point, the third past distance measurement value indicating a distance to the target object measured by the sensor at a fourth time point earlier than the third time point, and
wherein whether the target object has switched from a first target object to a second target object is determined based on the indicator, a first indicator, a second indicator, a third indicator, a fourth indicator, a fifth indicator, and a sixth indicator, the first indicator being an indicator that increases as a difference between the distance measurement value and the first past distance measurement value increases, the second indicator being an indicator that increases as a difference between the distance measurement value and the second past distance measurement value increases, the third indicator being an indicator that increases as a difference between the first past distance measurement value and the second past distance measurement value increases, the fourth indicator being an indicator that increases as the difference between the first past distance measurement value and the second past distance measurement value increases, the fifth indicator being an indicator that increases as a difference between the first past distance measurement value and the third past distance measurement value increases, the sixth indicator being an indicator that increases as a difference between the second past distance measurement value and the third past distance measurement value increases.

15. The processing method according to any one of claim 12,
wherein in a case where the target object has switched from the first target object to the second target object, the measurement value related to the first target object is not used to generate coordinates of the second target object.

16. The processing apparatus according to claim 1, wherein the instructions which, when executed by the hardware processor, further cause the hardware processor to perform operations comprising: calculating coordinates of the target object based on the distance measurement value.

17. The processing apparatus according to claim 16,
wherein in a case where the distance measurement value is determined to be a distance measurement value that is temporarily significantly different, the distance measurement value is not used in calculation of the coordinates of the target object.

18. The processing apparatus according to claim 3,
wherein in a case where the indicator is larger than a threshold, the distance measurement value is determined to be temporarily significantly different.

19. The vehicle according to claim 8, wherein the instructions which, when executed by the hardware processor, further cause the hardware processor to perform operations comprising:
determining a possibility of collision of the vehicle with the target object based on coordinates of the target object, and
outputting the control signal for causing the vehicle to avoid collision to the vehicle when there is the possibility of collision.

20. The vehicle according to claim 8,
wherein the sensor is configured to be a sensor which, in operation, detects a target in a direction lateral to a traveling direction of the vehicle.
